(19) United States
(12) Patent Application Publication
(10) Pub. No.: US 2007/0089157 A1
(43) Pub. Date: Apr. 19, 2007

(54) Television advertising number system

(76) Inventor: Christopher M. Clark, Knoxville, TN (US)

Correspondence Address: LUEDEKA, NEELY & GRAHAM, P.C., P O BOX 1871, KNOXVILLE, TN, 37901, US

(21) Appl. No.: 11/328,948

(22) Filed: Jan. 10, 2006

Related U.S. Application Data
(63) Continuation-in-part of application No. 11/253,195, filed on Oct. 18, 2005.

(51) Int. Cl. H04N 7/173; G06F 3/00; G06F 13/00; H04N 7/16; H04N 5/445

(52) U.S. Cl. 725/135; 725/42; 725/112; 725/113

(57) ABSTRACT

Supplemental program information is provided to a television in conjunction with a television program, where the supplemental program information is related to the subject matter of the television program. The supplemental program information and an access number are embedded in a digital video data stream of the television program. The digital video data stream is transmitted and received, and the access number is extracted from the received data stream. Based on the extracted access number, a determination is made whether the supplemental program information will be provided to the television. The television program may be an advertisement, and the supplemental program information may be advertising information related to the subject matter of the advertisement. For example, the supplemental program information may be a URL pointing to a web page that describes features of an advertiser's product. Once activated by a valid access number, a graphic image is inserted into the advertisement indicating that further product information is available on the web page.

### BACKGROUND

Increasingly, television programming is provided to consumers in a compressed digital format via cable, satellite or direct broadcast wireless signals. The leading standards for digital video compression are provided by the Moving Picture Experts Group (MPEG) and are referred to as MPEG-2 and MPEG-4. Generally, MPEG achieves a high compression rate by storing only the changes from video one frame to another, instead of each entire frame. The video information is then encoded, such as using direct cosine transform (DCT). MPEG uses a type of lossy compression, since some data is removed. But the diminishment of data is generally imperceptible to the human eye.

MPEG-2 offers resolutions of 720×480 and 1280×720 at 60 frames per second, with full CD-quality audio. MPEG-4 is a graphics and video compression algorithm standard that is based on MPEG-2 and Apple QuickTime technology. MPEG-4 is designed to transmit video and images over a narrower bandwidth than MPEG-2 and can mix video with text, graphics and 2-D and 3-D animation layers.

Although the MPEG and other video data compression standards are capable of providing television viewers high quality video images, the data stream is a “one way street.” These standards are not designed to provide television viewers an interactive viewing experience. Thus, other than switching channels and requesting pay-per-view movies, television viewers cannot truly interact with the television programming provided by cable and satellite television providers.

The Internet, on the other hand, allows users almost infinite interactive entertainment and information gathering opportunities. However, in general, the bandwidth at which Internet data is made available to users is considerably narrower than the bandwidth used by cable and satellite television providers. Thus, viewing real-time streaming video via the Internet, such as in MPEG-2 or MPEG-4 format, is not a practical option for most users.

What is needed, therefore, is a system for combining the high-quality streaming video information provided by cable and satellite television providers with the interactive entertainment, advertising and information gathering options provided by the Internet.

### SUMMARY

The above and other needs are met by a method for providing supplemental program information to a television display device in conjunction with a television program, where the supplemental program information is related to the subject matter of the television program. The method includes steps of (a) embedding the supplemental program information and an access number in a digital video data stream of the television program, (b) transmitting the digital video data stream of the television program and (c) receiving the digital video data stream of the television program. The method also includes (d) extracting the access number from the received digital video data stream of the television program, and (e) determining based on the extracted access number whether the supplemental program information is to be provided to the television display device.

In one preferred embodiment, the television program is a television advertisement, and the supplemental program information is advertising information related to the subject matter of the television advertisement. For example, the supplemental program information may be a uniform resource locator (URL) pointing to a web page that describes features of an advertiser's product. Once activated by a valid access number, a television/computer interface inserts a graphic image into the television advertisement indicating to a viewer that the supplemental program information is available.

In a most preferred embodiment, television broadcasters purchase blocks of access numbers from an access number provider. The television broadcasters may then resell the access numbers to advertisers to be embedded in television advertisements. Preferably, each access number may be used only once to activate the television/computer interface. To keep track of which access numbers are valid, the access number provider compiles a list of access numbers assigned to each television broadcaster. This list may be downloaded, such as via the Internet, to a home computer connected to the television/computer interface. As access numbers are used in advertisements, the home computer updates a log file indicating which access numbers have been used and listing other information relating to the use of the access numbers.

In another aspect, the invention provides a digital media interface apparatus for providing supplemental program information to a television display device in conjunction with a television program, where the supplemental program information is related to the subject matter of the television program. The apparatus includes a television/computer interface for receiving a digital media data stream containing the television program and for extracting an access number embedded in the digital media data stream. The apparatus also includes a computer in communication with the television/computer interface and in communication with a communication network. The computer receives the extracted access number from the television/computer interface and receives a list of access numbers via the communication network. The computer then determines whether the extracted access number corresponds to an access number in the list. If the extracted access number corresponds to an access number in the list, the computer provides the supplemental program information to the television/computer interface. The television/computer interface then combines the supplemental program information with the television program to form a combination video signal in a format compatible for display on the television display device.

In a most preferred embodiment, a broadcaster registration code is also embedded the digital media data stream. The television/computer interface extracts the broadcaster registration code from the digital media data stream and provides the broadcaster registration code to the computer. The computer then determines whether the extracted broadcaster registration code corresponds to a broadcaster registration code listed with the access numbers in the list. If the extracted broadcaster registration code corresponds to a listed broadcaster registration code, and if the extracted access number corresponds to a listed access number, the computer provides the supplemental program information to the television/computer interface.

In one preferred embodiment, the computer of the digital media interface apparatus determines whether the extracted access number has been previously extracted from a digital media data stream. If the extracted access number has not been previously extracted from a digital media data stream and the extracted access number corresponds to a listed access number, the computer provides the supplemental program information to the television/computer interface.

In some preferred embodiments, the television/computer interface extracts an access number and a uniform resource locator (URL) from the digital media data stream, where the URL points to a web page related to subject matter of the television program. If the extracted access number corresponds to an access number in the downloaded list, the computer provides access to the web page for viewing on the television display device.

In yet another aspect, the invention provides a digital media interface apparatus for providing supplemental program information to a television display device in conjunction with a television program, where the supplemental program information is related to the subject matter of the television program. The apparatus includes means for embedding the supplemental program information and an access number in a digital video data stream of the television program, means for transmitting the digital video data stream of the television program, and means for receiving the digital video data stream of the television program. The apparatus also includes means for extracting the access number from the received digital video data stream and for determining based on the extracted access number whether the supplemental program information is to be provided to the television display device.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a digital media interface system according to a preferred embodiment of the invention;

FIG. 2 depicts a television/computer interface portion of a digital media interface system according to a preferred embodiment of the invention;

FIG. 3 depicts a computer portion of a digital media interface system according to a preferred embodiment of the invention;

FIG. 4 depicts a digital media interface system according to an alternative embodiment of the invention;

FIGS. 5-7 depict a television/computer interface portion of a digital media interface system according to alternative embodiments of the invention;

FIG. 8 depicts further details of a digital media interface system according to a preferred embodiment of the invention;

FIG. 9 depicts a portion of an MPEG-2 digital media data stream according to a preferred embodiment of the invention;

FIGS. 10A-10C depict examples of television screen graphics generated by a digital media interface system according to a preferred embodiment of the invention;

FIG. 11 depicts a digital media interface system according to another alternative embodiment of the invention;

FIG. 12 depicts a method of operating a digital media interface system according to a preferred embodiment of the invention;

FIG. 13 depicts a digital media interface system in communication with an access number provider system according to a preferred embodiment of the invention;

FIGS. 14A and 14B depict a method of providing access numbers and operating a digital media interface system using access numbers according to a preferred embodiment of the invention;

FIG. 15 depicts an access number log sheet according to a preferred embodiment of the invention; and

FIG. 16 depicts a television/computer interface portion of a digital media interface system according to a preferred embodiment of the invention.

### DETAILED DESCRIPTION

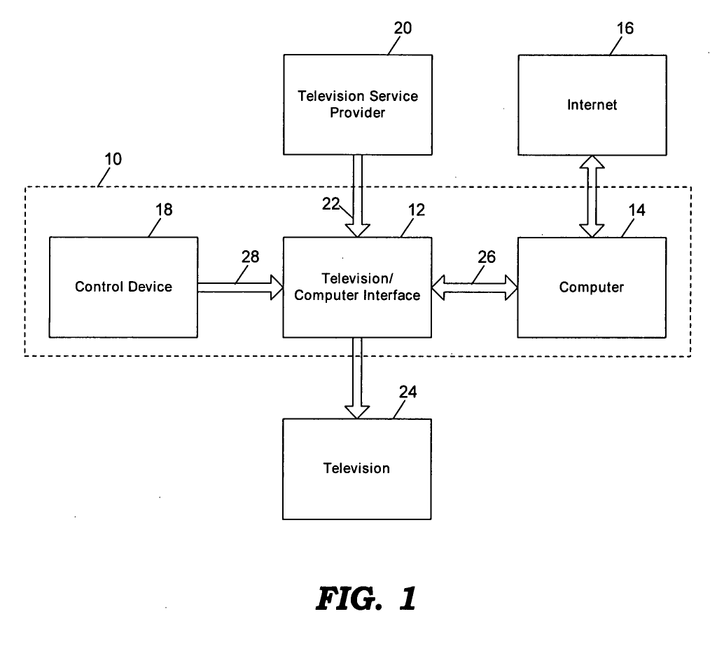

FIG. 1 depicts a preferred embodiment of a television interface system 10 according to the present invention. The system 10 includes a television/computer interface 12, a computer 14 connected to the Internet 16 and one or more remote control devices 18. The television/computer interface 12, which is also referred to herein as a set-top box (STB), receives a digital media signal from a television service provider 20, such as a satellite or cable television provider. The digital media signal is provided to the STB 12 via a connection 22 which may comprise a coaxial cable, an Ethernet connection, wireless signal or other means of signal transfer. As described in more detail hereinafter, the STB 12 decodes the digital media signal and provides it to a television viewing unit 24, such as a CRT, LCD or plasma monitor or a projector.

The STB 12 also receives a digital information signal from the computer 14 via a connection 26, which may be a wired or wireless local area network, Universal Serial Bus (USB) or direct bus connection, such as PCI. According to preferred embodiments of the invention, the STB 12 combines the digital information signal from the computer 14 with the digital media signal from the television service provider 20 to form a combined graphics signal. This combined signal is then provided to the television viewing unit 24.

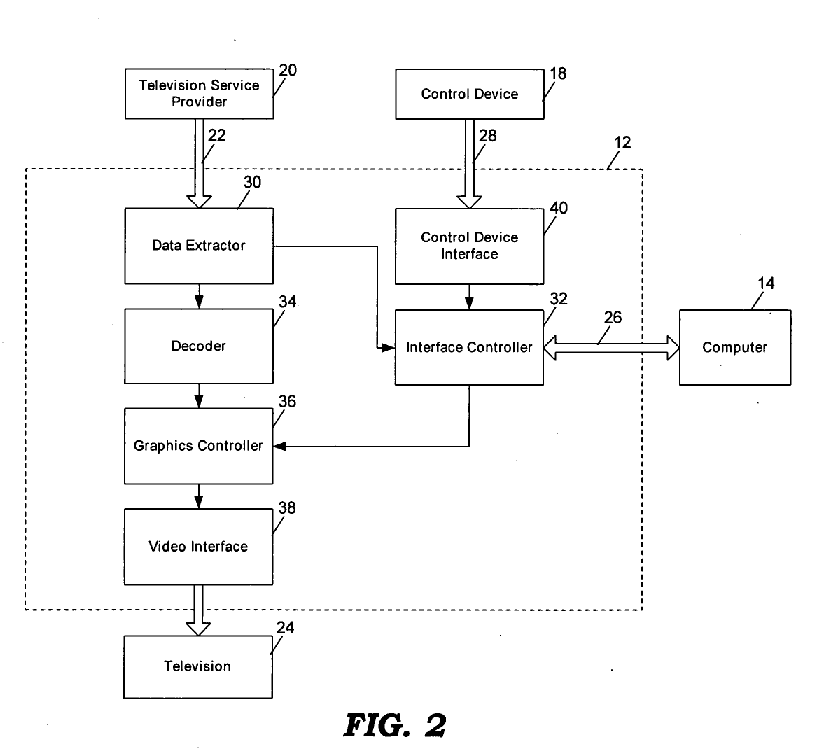

FIGS. 2 and 16 depict components of the STB 12 according to preferred embodiments of the invention. The STB 12 includes a data extractor 30 that receives the digital media stream from the television service provider 20. Embedded in the digital media stream is “user data,” also referred to herein as “consumer-oriented data.” The purpose of the data extractor 30 is to extract or copy the user data and provide it to the computer 14.

User data may be present in the digital media stream 22 for various purposes, such as to identify the source of the associated video program or the particular type of software that was used to produce or encode the video data. As described in more detail hereinafter, user data may also be used to provide information to consumers regarding products or services depicted in the associated video program.

The user data is typically embedded in a user data section of the digital media stream. As described in more detail below, the data extractor 30 monitors the encoded digital media stream and “listens” for the beginning of a user data section. When a user data section is detected, the data extractor 30 copies the user data from the encoded data stream and passes it to an interface controller 32. The interface controller 32 sends the copied data from the data extractor 30 to the computer 14 over the connection 26. Although the user data is copied from the digital media stream as it passes through the data extractor 30, the digital media stream that enters the STB 12 on the connection 22 passes through the data extractor 30 substantially unaltered.

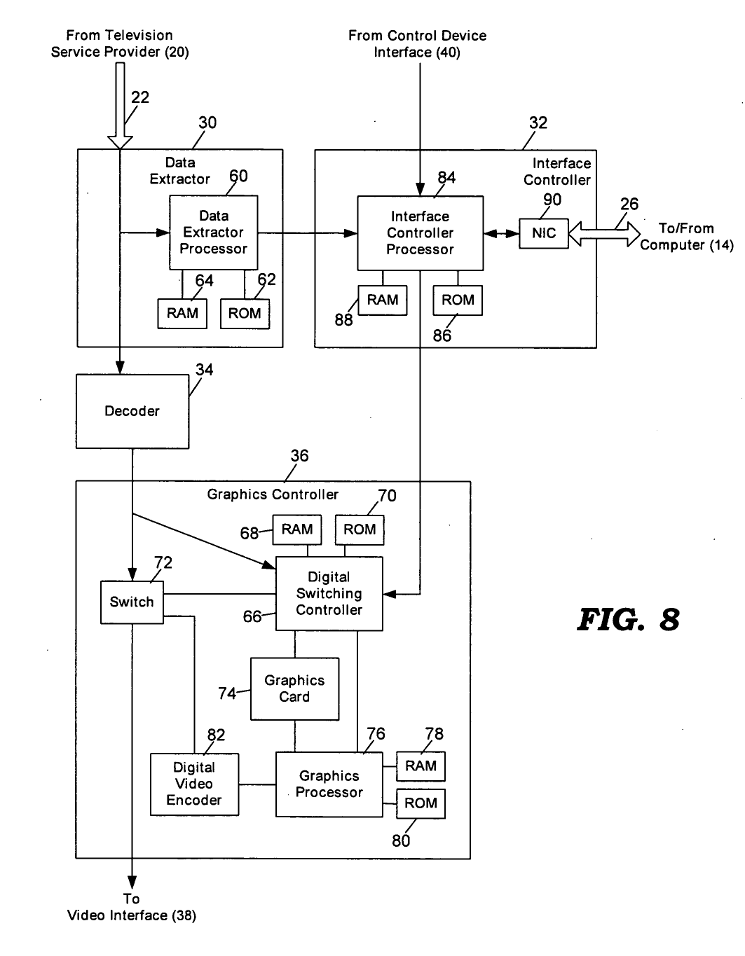

In preferred embodiments of the invention, the data extractor 30 functions as a listening port patched onto the digital media data stream 22. As shown in FIG. 8, the data extractor 30 includes a data extractor processor 60 that monitors the data stream 22 for sequences of the user data in the digital media signal. The data extractor 30 also include read-only memory (ROM) 62 for storing programming instructions and random access memory (RAM) 64 for temporary storage of data.

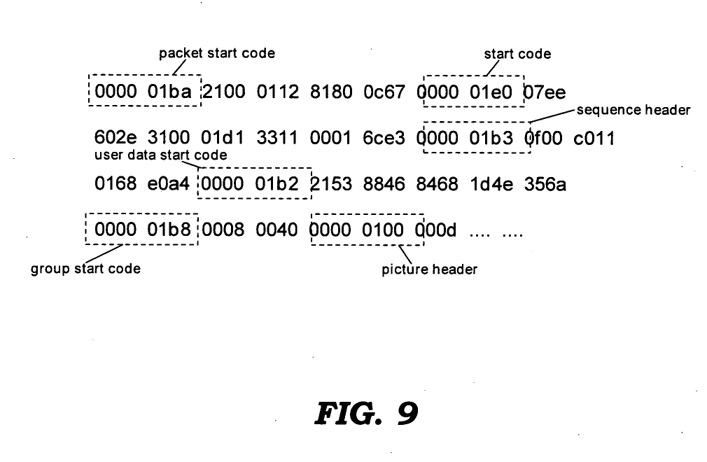

To provide background for describing the operation of the data extractor 30, the data format of an MPEG-2 data stream is first described with reference to FIG. 9, which represents typical MPEG-2 data in hexadecimal format. As shown in FIG. 9, an MPEG-2 data stream may include a number of different “start codes” that indicate the beginning of various portions of the data stream. According to the MPEG-2 standard for digital video as set forth in ISO/IEC 13818-2, start codes are specific bit patterns that do not otherwise occur in the video stream. Each start code consists of a start code prefix followed by a start code value.

According to the MPEG-2 standard, the start code prefix is a string of twenty three bits with the value of zero followed by a single bit with the value one. Thus, the start code prefix is the bit string “0000 0000 0000 0000 0000 0001” (0000 01 in hexadecimal). Immediately following the start code prefix is the start code value. The start code value is an eight bit integer that identifies the type of start code. Most types of start code have just one start code value.

The start code value for the “user data” portion of the MPEG-2 stream is “b2” in hexadecimal. Thus, as shown in FIG. 9, the hexadecimal value for the user data start code is “0000 01b2.” The actual user data comprises all the data in the data stream that follows the user data start code and precedes a stop code (or the next start code). The user data section can be of any length. In the example of FIG. 9, the user data comprises the string “2153 8846 8468 1d4e 356a.”

The SMPTE Registration Authority, LLC is currently authorized by the International Organization of Standardization (ISO) to register MPEG-2 format identifiers. The registration descriptor of MPEG-2 standard is provided by ISO 13818-1 to enable users of the MPEG-2 standard to unambiguously carry data when the format of the data is not necessarily a recognized international standard. This provision permits the MPEG-2 video transport standard to carry various types of data while providing for a method of unambiguous identification of the characteristics of underlying private data.

Entities that are registered with SMPTE are assigned a unique code that can be recognized in the video stream. Using this registration code, a registered entity can embed specific user data in the video data stream. The registration code can also be used to locate and extract the user data.

With reference to FIG. 8, the data extractor processor 60 listens for the user data start code (0000 01B2) in the MPEG-2 data stream Based on programming instructions stored in the ROM 62. Once the user data start code is detected, the processor 60 jumps to another section of programming in the ROM and begins listening for an appropriate registration code. When the registration code is detected, the processor 60 begins copying all the preceding data into the RAM 64 until a stop code is detected. The processor 60 forwards the data saved in the RAM 64 to the interface controller 32. The processor 60 then recycles and begins listening for the next user data start code.

After the video stream passes through the data extractor 30, a decoder 34, such as an MPEG-2 or MPEG-4 decoder, decodes the digital media stream into a pure digital luminance/chrominance (Y/C) signal. The decoded media signal is provided to a graphics controller 36 which combines the media stream data with graphics data from the computer 14, if it is instructed to do so. Finally, depending again on the application of the STB 12 and the type of television viewing device 24 in use, the digital media signal may be converted into an analog signal in a video interface 38. Thus, depending on the particular embodiment of the invention, the signal provided to the television viewing device 24 may be component video, composite video, Digital Visual Interface (DVI), High-Definition Multimedia Interface (HDMI) or other video or multimedia format.

As discussed in more detail hereinafter, the computer 14 sends graphics data and commands via the connection 26 to the interface controller 32. The interface controller 32 relays the graphics data from the computer 14 to the graphics controller 36. The graphics controller 36 embeds the graphics data from the computer 14 into the original digital media stream that passed through the data extractor 30. The graphics controller 36 also develops the appropriate graphics for display on the television viewing device 24 based on the combined digital media and computer graphics signals.

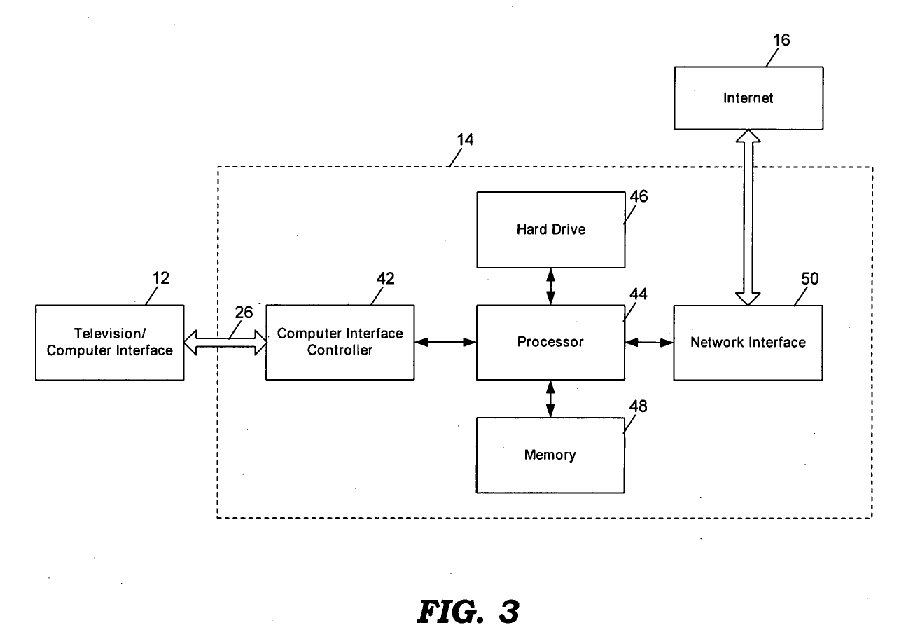

FIG. 3 depicts a preferred embodiment of the computer 14, which comprises a computer interface controller 42, a processor 44, a hard drive 46, memory 48 and a communication network interface 50. The interface controller 42 may be a local area network interface card, a USB controller or an address/data bus, such as a PCI bus. The interface controller 42 provides the data interface between the STB 12 and the processor 44.

Using the hard drive 46 and the memory 48, the processor 44 processes the data from the STB 12 depending on the type of data received. If the data is a request for an Internet link to be shown on the television display device 24, the processor 44 uses browser software to fetch the requested link data via the network interface 50. Based on the link data, the processor 44 generates graphics instructional data and provides the graphics instructional data to the computer interface controller 42 to be sent to the STB 12 via the connection 26.

The interface controller 32 of the STB 12 receives the graphics instructional data from the computer interface controller 42 and provides this data to the graphics controller 36. As described in further detail below, the graphics instructional data provides information to the graphics controller 36 regarding how to display the link information that was requested. Based on the graphics instructional data, the graphics controller 36 develops the appropriate link graphics and embeds the link graphics into the digital video stream. For example, the link graphics may comprise a computer “window” displaying a web page corresponding to the link information. This window is shown on the television display device 24 as an overlay on the original digital video signal. In the preferred embodiment, the overlaid computer window appears on the display device 24 the same manner as it would in a browser window displayed on a computer screen.

As shown in FIG. 8, the interface controller 32 includes an interface controller processor 84 that is in communication with to the control device interface 40, data extractor 30 and graphics controller 36. The control device interface 40 and the data extractor 30 provide data to the processor 84 which operates on the data based on instructions stored in the ROM 86. These instructions determine how the processor 84 is to modify the input data so that it can be sent to the network interface card (NIC) 90 and on to the computer 14 in a format that can be understood by software running on the computer 14. After the data is modified appropriately, it is stored to the RAM 88 until it is sent to the NIC 90.

Preferably, these operations work in the same manner in reverse. When the NIC 90 receives data from the network 26, it sends the data to the processor 84. The processor 84 then uses instructions from the ROM 86 to modify the data appropriately to send it on to the graphics controller 36. The modified data is then stored in the RAM 88 until the proper time to be forwarded to the graphics controller 36.

As shown in FIG. 8, the graphics controller 36 provides a system for generating graphics and embedding them synchronously into the digital media stream. In a preferred embodiment of the invention, the graphics controller 36 includes a digital switching controller 66 with associated RAM 68 and ROM 70, a data switch 72, graphics card 74, graphics processor 76 with associated RAM 78 and ROM 80, and a digital video encoder 82.

In the preferred embodiment, the digital switching controller 66 receives its instructions from the interface controller 32 and divides those instructions into graphics instructions and embedding instructions. The digital switching controller 66 forwards the graphics instructions to the graphics card 74 and saves the embedding instructions in RAM 68.

The digital switching controller 66 is also responsible for monitoring the digital media signal that passes through the data extractor 30, preferably in the same manner as the data extractor 30 monitors the digital media signal 22. The digital switching controller 66 monitors the digital media signal for the appropriate location in the data stream to activate the switch 72 to allow graphics to be embedded in the stream. This embedding location is determined based on the embedding instructions that were stored in RAM 68. In a normal mode, the switch 72 allows the digital media signal to pass unaltered. When the switch 72 receives appropriate instructions from the digital switching controller 66, the switch 72 is operated in a graphics insertion mode wherein graphics created in the graphics processor 76 are synchronously inserted into the video stream. In the preferred embodiment, this synchronous switching is accomplished using switching logic gates in the switch 72. An example of a similar switching scheme is that used in cable or satellite set-top boxes to insert programming guide graphics into a video signal along with an incoming video program signal.

In the preferred embodiment, the graphics card 74 operates in the same manner as graphics cards used in personal computers. The graphics card 74 receives the graphics instructions from the digital switching controller 66 in a format which is the same as, or very similar to, the format such instructions would be provided by a personal computer. Thus, in the preferred embodiment, the graphics card 74 perceives that the graphics instructions came directly from the computer 14.

Based on the graphics instructions from the digital switching controller 66, the graphics card 74 outputs the graphics data that the graphics processor 76 copied to its RAM 78. The graphics processor 76 then waits for a signal from the digital switching controller 66 that it is time to embed the graphics data into the digital media signal. When the digital switching controller 66 tells the graphics processor it is time to embed the graphics data, it either tells the graphics processor 76 how much data it is going to embed or it tells the graphics processor 76 when to stop.

When the graphics processor 76 is instructed to embed the graphics data, it outputs the data to the digital video encoder 82 which converts the data to the appropriate video format. For example, if the graphics card 74 created the graphics data in RGB format, the digital video encoder 82 converts the data into digital video luminance/chrominance (Y/C) format. The digital video encoder 82 then outputs the data to the switch 72 which embeds the graphics data into the digital media signal.

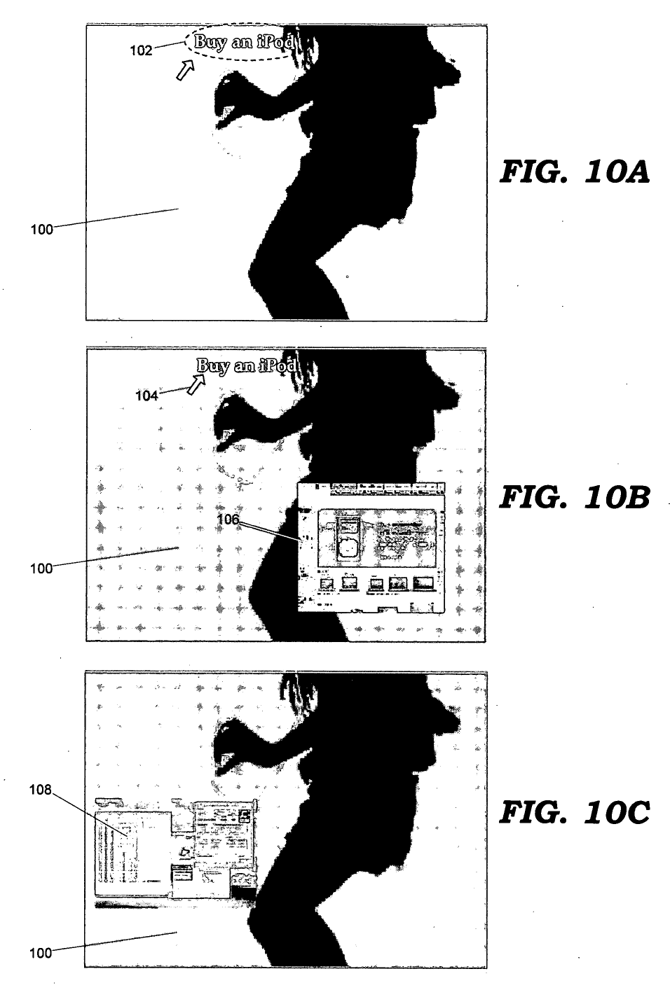

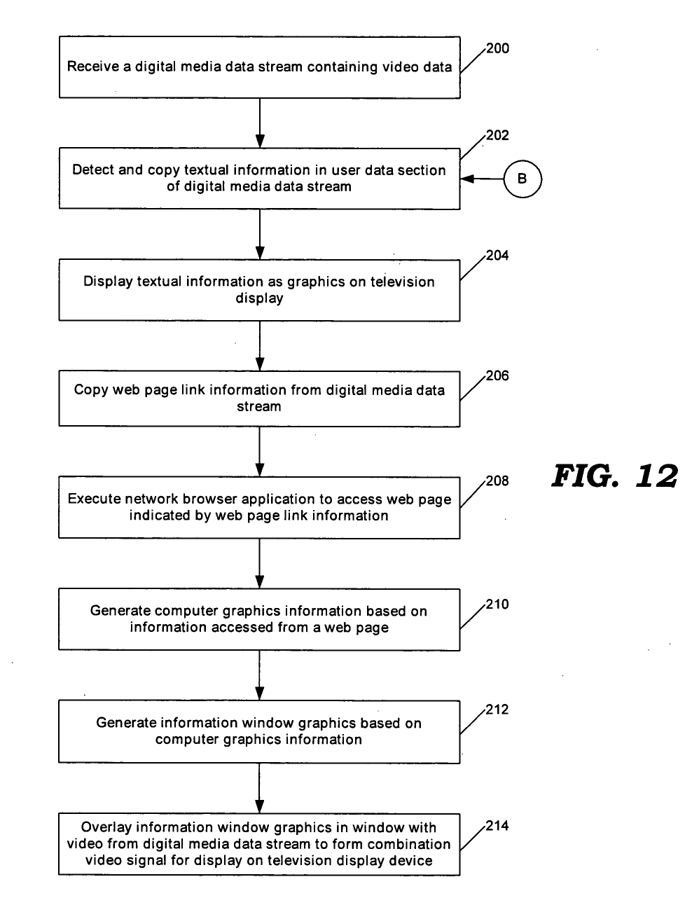

FIGS. 10A and 10B depict an example of television screen graphics generated by a preferred embodiment of the invention. FIG. 12 depicts steps performed in generating the screen graphics of FIGS. 10A and 10B. As shown in FIG. 10A, while receiving a video data stream depicting a television advertisement 100 for an Apple IPod (step 200 in FIG. 12), the data extractor 30 detects and copies user data in the video data stream that includes the textual phrase “Buy an iPod” (step 202). Based on this user data, the graphics controller 36 generates a graphical representation of the same textual phrase and embeds it in the digital media signal as described previously. As a result, the graphical representation 102 of “Buy an iPod” appears on the television display along with the video information for the television advertisement 100 (step 204).

In this example, the user data detected by the data extractor 30 also includes link information about a website where a consumer may obtain further information and/or purchase an iPod. This link information may be provided as a URL or an IP address. When detected, the link information is copied and sent to the interface controller 32 which provides the information to the computer 14 (step 206).

When a user sees the text graphics 102 appear on the television screen, this indicates to the user that further information regarding the advertised product is available on the Internet 16. To access that product information, the user presses a button on a remote control device 18 (see FIGS. 2 and 16) to activate the interface controller 32 to send a request signal to the computer 14. In response to the request signal, the computer 14 accesses the associated web site, such as using a browser application (step 208). In an alternative embodiment, the user may use a mouse, touch pad or remote control, to position a curser 104 to click on the text graphics 102 which activates the interface controller 32 to send the request signal to the computer 14.

Continuing the example of FIGS. 10A and 10B, the computer 14 then accesses the web site and provides graphic information for generating the web page to the interface controller 32 (step 210). As described above, the interface controller 32 provides the web page graphics information to the graphics controller 36 which embeds the web page graphics into the digital media stream (step 212). As shown in FIG. 10B, the web page then appears in a window 106 on the television display device (step 214). Using the control device 18, the interactive functions provided in the web page window 106 may then be accessed in the same manner as if the web page were being viewed on a computer display connected directly to the computer 14. At the same time, the video program 100 continues on the television display “behind” the window 106.

According to a preferred embodiment of the invention, the graphical “relay” provided by the interface controller 32 and the graphics controller 36 also allows a user to view on the television display device 24 the graphics generated by any computer application running on the computer 14. In this manner, the user may take advantage of all the computer's functionality from in front of the television display device 24, such as word processing or email applications, or a full desktop environment. FIG. 10C depicts an example of the computer desktop displayed in a window 108 as a video program 100 continues on the television display “behind” the window 108.

In the preferred embodiment of the invention, the control device 18 comprises one or more USB control devices, such as a keyboard, touchpad, mouse, remote control or other user interface unit used to control the functionality of the STB 12 or the computer 14 or both. In the preferred embodiment, the control device 18 includes a USB keyboard and mouse. The control device 18 communicates via a connection 28 with a control device interface 40 in the STB 12. The connection 28 may be either wireless, such as infrared or RF, or wired. The control device interface 40 provides the control commands to the interface controller 32 which communicates the commands to the computer 14. Interface software running on the computer 14 allows the control device 18 to function with the computer 14 as if it was connected directly to the computer. Commands from the control device 18 can also trigger graphics to appear on the television display device 24.

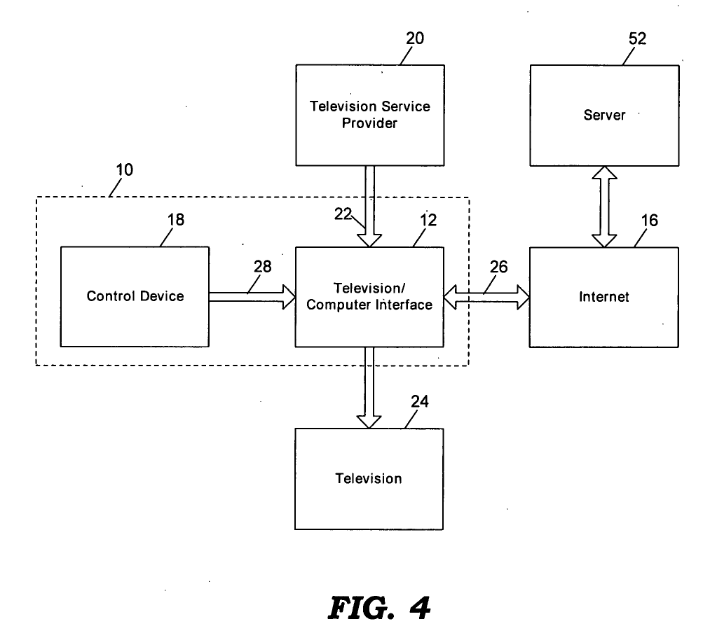

In an alternative embodiment of the invention depicted in FIG. 4, instead of being connected to a personal computer over a local area network, the STB 12 is connected to an off-site server computer 52 over a communication network 16, such as the Internet or a virtual private network. In this embodiment, the connection 26 is an Internet or VPN connection to a cable modem in the interface controller 32 of the STB 12. The server 52 provides many of the same services as provided by the computer 14 of the embodiment depicted in FIGS. 1, 2 and 3. In this alternative embodiment, however, the server 52 provides Internet access and email for users that do not have a personal computer.

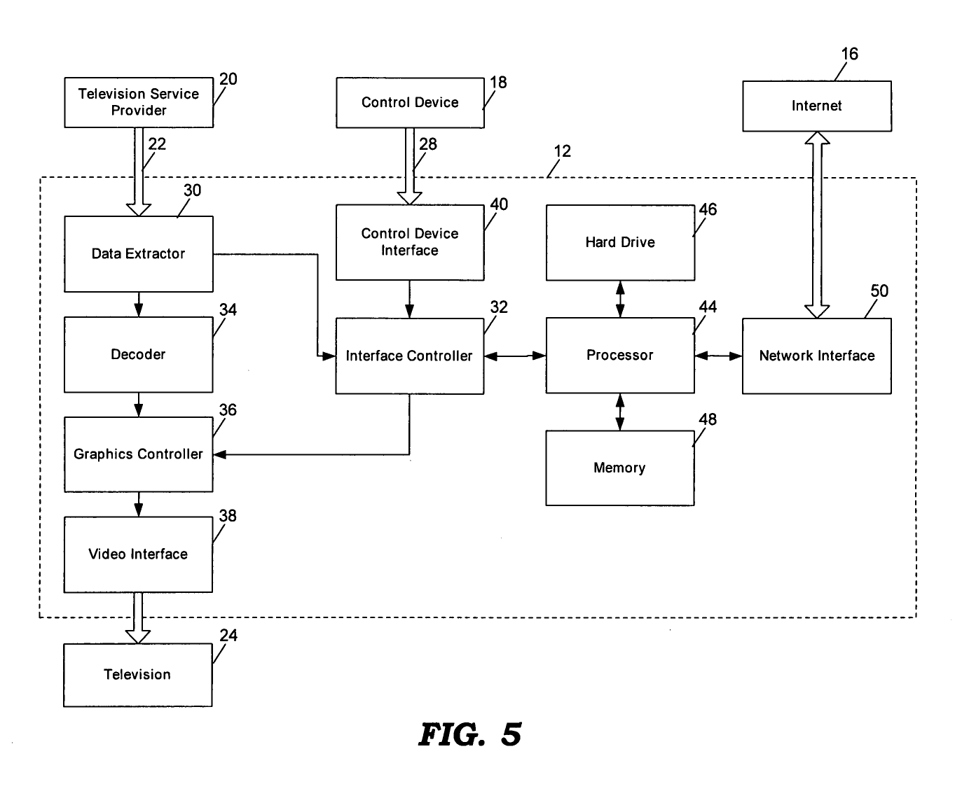

In another alternative embodiment of the invention, the components of the computer 14 are incorporated into the STB 12. As shown in FIG. 5, the processor 44 of this embodiment communicates directly with the interface controller 32, such as via a PCI bus. Otherwise, this embodiment functions in the same manner as the system depicted in FIGS. 1, 2 and 3.

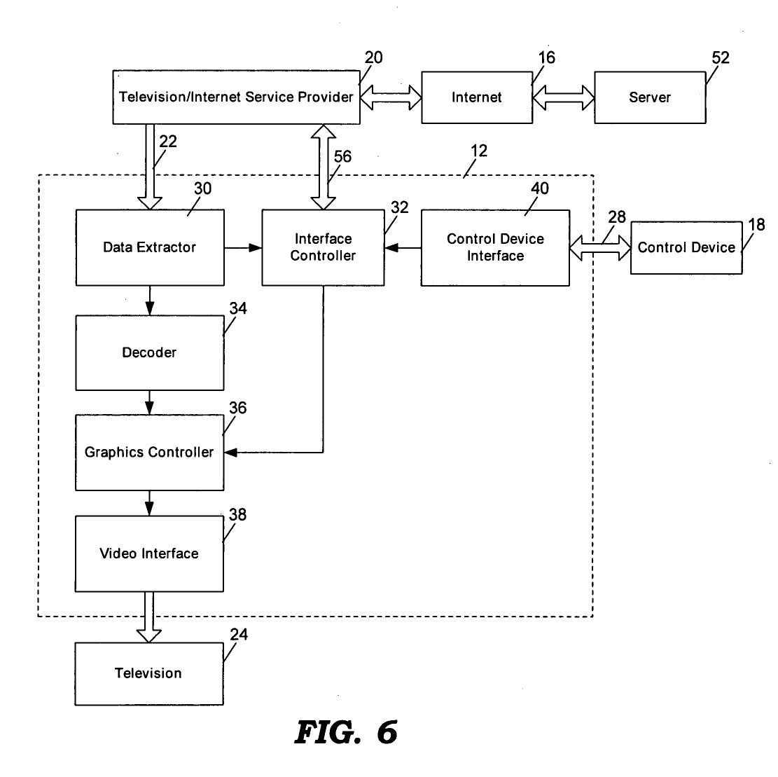

In another alternative embodiment depicted in FIG. 6, the interface controller 32 of the STB 12 accesses the Internet 16 via a two-way interface provided by the television service provider 20, such as through a cable or satellite modem connection 56. In this embodiment, the interface controller 32 connects to the television service provider 20 which provides an Internet or VPN connection to an off-site server 52.

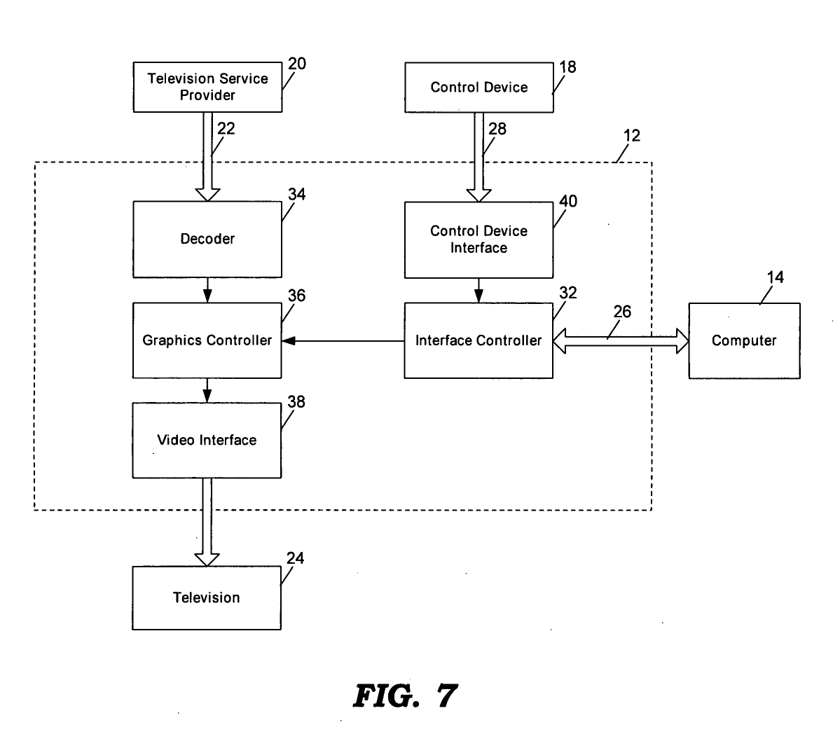

Yet another embodiment of the invention is depicted in FIG. 7. This embodiment functions in substantially the same manner as the embodiment of FIG. 2 except that no consumer oriented data is extracted from the digital media stream. Thus, any graphics the user chooses to display in the window overlaid on the screen of the display device 24 is not necessarily related to any consumer information in the digital media stream.

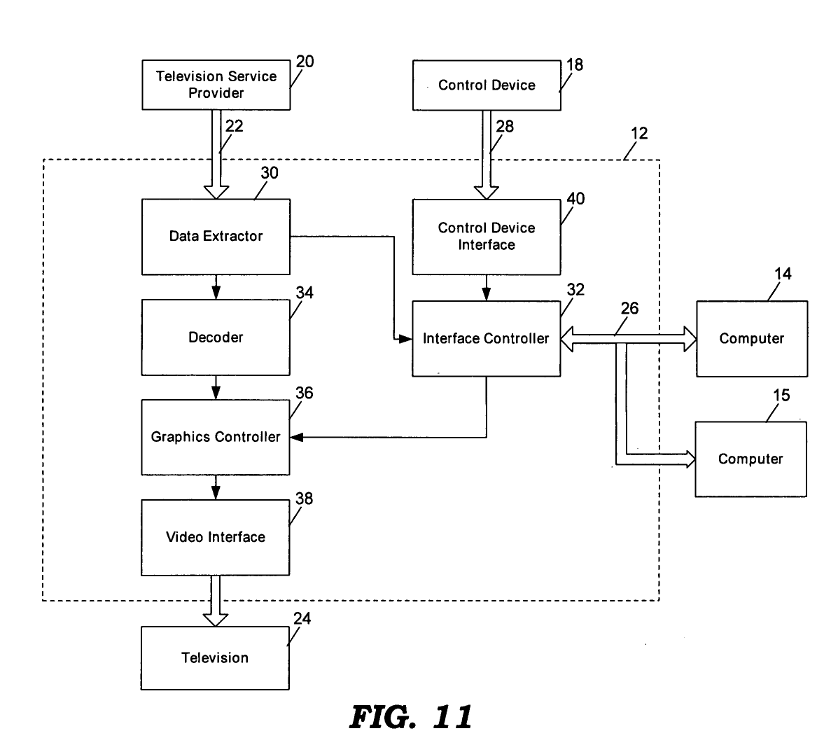

In an embodiment of the invention depicted in FIG. 11, the computer 14 is in communication with a second computer 15, such as a portable laptop computer, so that the computer 14 can send the website data to the second computer 15. For example, using the embodiment of FIG. 11, a user may be watching a television program while surfing the web on the computer 15 at the same time. When link graphics, such as the graphics 102 in FIG. 10A, appear on the television and the user clicks on the link graphics 102 using the interface device 18, instead of displaying the web page on the television, the web page is displayed on the screen of the second computer 15. This function may be activated as an option that is selected in an on-screen setup menu provided on the television screen. In this embodiment, the computer 15 is running application software that can respond to the requests and information from television/computer interface 12. Thus, the computer 15 can send and receive data to and from the computer 14 and the television/computer interface 12.

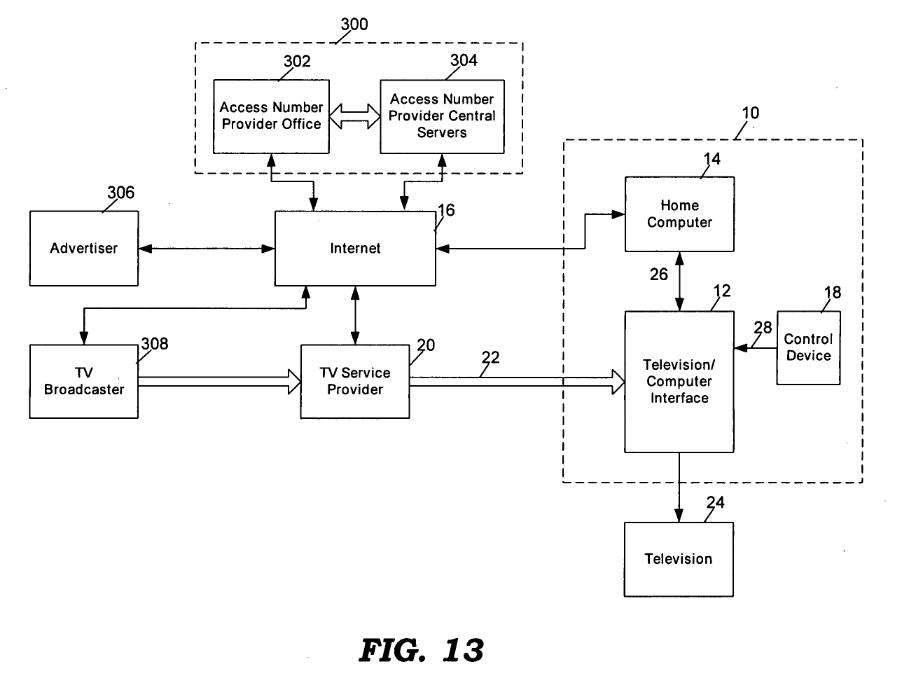

FIG. 13 depicts an embodiment of the invention wherein access to the user data embedded in the digital media signal is enabled by advertising access numbers provided by an access number provider system 300. The access number provider system 300 communicates via a communication network 16, such as the Internet, with advertisers 306, television broadcasters 308 and television service providers 20. As used herein, the phrase “TV broadcaster” refers to television networks such as the American Broadcasting Company (ABC), television stations such as WBIR in Knoxville, Tenn., and cable/satellite television channels such as Home and Garden Television (HGTV). The phrase “TV service provider” as used herein refers to cable television providers such as Comcast and satellite television providers such as DirecTV. When reference is made herein to the advertisers 306, the TV broadcasters 308 and the TV service providers 20, it will be appreciated that these references refer to the entities and to computer systems and communication networks used by the entities in providing their services.

According to the embodiment of FIG. 13, the access number provider system 300 maintains and administers blocks of access numbers that may be provided to the TV broadcasters 308 and TV service providers 20. As described in more detail below, the TV broadcasters 308 and TV service providers 20 may embed the access numbers in the user data portions of digital media signals to activate the television interface system 10 to insert advertising-related screen graphics on the television 24 of a TV service consumer.

In a most preferred embodiment, the blocks of access numbers are sold to the TV broadcasters 308 and TV service providers 20. These entities then may sell use of the numbers to advertisers 306 so the advertisers may promote their products or services using the user data embedded in the digital media data stream. For example, once a purchase of access numbers has been negotiated, the access number provider system 300 may transfer a block or range of access numbers to the TV broadcaster 308, such as HGTV. HGTV may then sell the use of one or more of these numbers to an advertiser 306, such as Home Depot, for use in activating the television interface system 10 during one or more of Home Depot's commercials that air on HGTV.

A TV broadcaster 308 or TV service provider 20 may also use the access numbers to activate the television interface system 10 to promote their own programming. For example, during a promotional spot for one of ABC's television programs, ABC may use an access number to activate the television interface system 10 to provide a link to a webpage that describes the program. Similarly, a satellite or cable TV service provider 20, such as Comcast or DirecTV, may use an access number to activate the television interface system 10 to provide a link to a webpage describing how to purchase pay-per-view movies.

In the preferred embodiment, the access numbers are bought and sold using the communication system depicted in FIG. 13. The access number provider system 300 preferably includes an access number provider office computer 302 that communicates via the network 16 with the TV broadcasters 308, TV service providers 20 and advertisers 306. In one embodiment of the invention, the TV broadcaster 308 or service provider 20 may access a webpage maintained by the access number provider office 302 to purchase a block of access numbers. This webpage provides the interface for the TV broadcaster 308 or service provider 20 to request the numbers, transfer funds for their purchase and activate the numbers for use.

The access number provider system 300 also includes an access number provider central server 304 on which records are maintained of the blocks of access numbers that have been sold to particular TV broadcasters 308 or service providers 20, which of those numbers are still active for use, which numbers have been used and how and when they were used. Information regarding how and when the numbers were used comprises market research data which may be of significant value to the TV broadcasters 308, service providers 20 and advertisers 306.

In the preferred embodiment of the invention, each access number may be used only once. Thus, once a particular access number has been embedded in a digital media data stream and used to activate the television interface system 10, that number is deactivated and may not be used again to activate the system 10. As described in more detail hereinafter, the home computer 14 keeps a record of which access numbers are active and which have been deactivated based on prior use.

In some preferred embodiments, the access number provider system 300 also assigns the registration codes to registered entities, and maintains and administers the assigned registration codes. The registered entities may include TV broadcasters (such as HGTV and ABC) and TV service providers (such as DirecTV and Comcast). Preferably, the access number provider system 300 also maintains and administers advertiser identification numbers assigned to advertisers that have registered with the access number provider to use the system.

As shown in FIG. 13, an advertiser 306 communicates with the access number provider 300, the TV broadcaster 308 and the TV service provider 20 by way of the communication network 16, which is preferably the Internet. Using the advertiser computer system 306 in communication with the access number provider system 300, an advertiser may acquire an advertiser identification number. In one embodiment of the invention, the advertiser 306 accesses a webpage maintained by the access number provider office 302 to apply for an advertiser identification number.

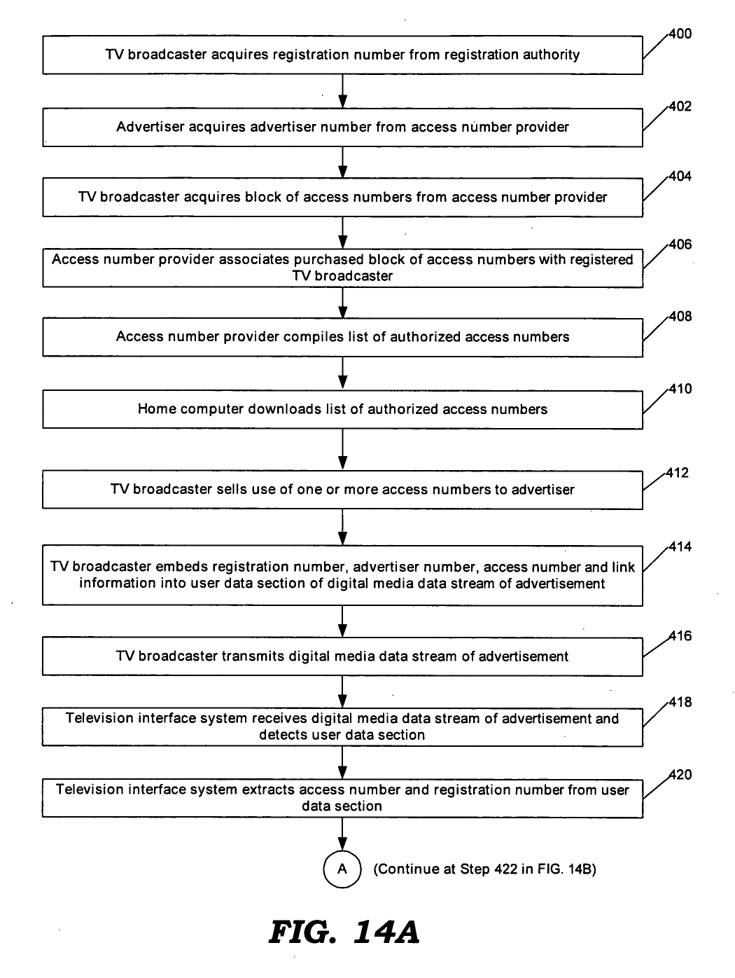

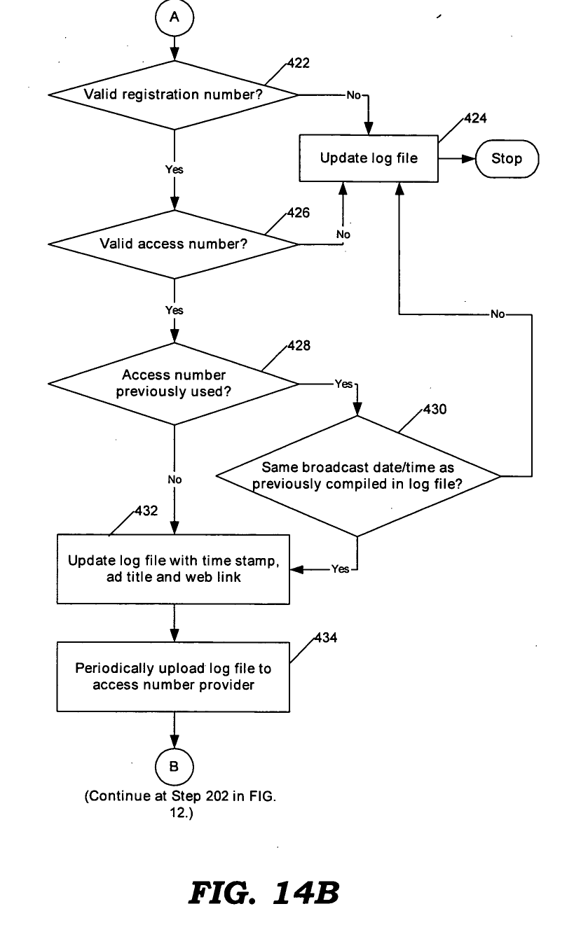

FIGS. 14A and 14B depict steps of a method for acquiring and using advertising access numbers using the system depicted in FIG. 13. As discussed previously, the TV broadcaster 308 or service provider 20 acquires a registration code from the access number provider 302 (step 400), and the advertiser acquires an advertiser number from the access number provider office 302 (step 402). Once registered, the TV broadcaster 308 or service provider 20 may acquire a block or range of access numbers from the access number provider office 302 (step 404). In the preferred embodiment, this acquisition is a purchase involving a transfer of revenue from the TV broadcaster 308 or TV provider 20 to the access number provider 300. The access numbers in the purchased block are then associated with the registration code of the TV broadcaster 308 or TV provider 20 in a database maintained on the access number provider central server 304 (step 406).

With continued reference to FIGS. 13 and 14A, lists of purchased access numbers and associated registration codes are compiled in the access number provider central server 304 (step 408). Preferably, each of these lists is customized for a particular user of the television interface system 10 to include only those TV broadcasters 308 and service providers 20 that serve that particular user. For example, if a particular user receives TV service from only one satellite TV service provider 20, such as DirecTV, then the list compiled for that user includes only the registration codes and access numbers assigned to DirecTV and to TV broadcasters 308 whose programming is provided to the user via DirecTV. In some embodiments, these lists are further customized to include only those TV broadcasters 308 that are included in the particular satellite or cable service package selected by the user. For example, if the user's service package does not include ESPN2, then the customized list of access numbers would not include access numbers assigned to ESPN2. Preferably, these lists are also customized to include only those local on-air TV broadcasters 308 whose service area includes the geographic location of the user. For example, if the geographic location of the user is not within the broadcast service area of TV station WBIR in Knoxville, then the customized list of access numbers would not include access numbers assigned to WBIR.

Periodically, the user's home computer 14 downloads an up-to-date list of authorized access numbers from the access number provider central server 304, such as via the Internet 16 (step 410). In a preferred embodiment, this download occurs automatically on a weekly or daily basis. In an alternative embodiment, the list is downloaded via a telephone connection to the television/computer interface 12 which stores the list in memory or transfers the list to the home computer 14 for storage. In yet another embodiment, the list is transferred from the access number provider server 304 to the television service provider 20 via the Internet 16 and then to the television/computer interface 12 via the connection 22. Thus, it should be appreciated that the invention is not limited to any particular method of transferring the access number list to the home computer 14.

Once a TV broadcaster 308 or TV service provider 20 has acquired a block of access numbers, the TV broadcaster or service provider may sell or otherwise transfer one or more of the access numbers to an advertiser 306 for use in an advertisement to be aired by the TV broadcaster (step 412). The TV broadcaster 308 or service provider 20 may use one or more of the access numbers to promote their own television programs or services. As discussed previously, a sale or other transfer of rights to use the access numbers may occur by way of Internet communications between the TV broadcaster 308 (or the TV service provider 20) and the advertiser 306, such as by email or web page access.

Once an access number has been sold to an advertiser 306 for use in an advertisement, the TV broadcaster 308 inserts the access number into the user data section of the digital media data stream of the advertisement as provided by the advertiser 306 (step 414). Alternatively, the advertiser 306 may insert the access number into the user data section before the advertisement is provided to the TV broadcaster 308. In the preferred embodiment, the registration code of the TV broadcaster 308 or service provider 20 and the advertiser identification number of the advertiser 306 are also embedded in the user data section.

The advertisement is then transmitted by the TV broadcaster 308 (or the TV service provider 20) as part of the programming provided in the digital media data stream to the consumer (step 416). The transmission is received by the television interface system 10 which detects the beginning and end of the user data section of the advertisement (step 418) as described previously herein.

With reference to FIGS. 8, 14A and 14B, once the user data start code is detected by the data extractor processor 60 of the television interface system 10, the processor 60 copies all the data in the user data section to the RAM 64 until the user data stop code is detected (step 420). The data copied to the RAM 64 preferably includes at least the registration code, the access number, the advertiser number and the webpage link information that was previously written into the user data section of the data stream of the advertisement. Other information may also be included in the user data section, such as the title of the advertisement and the date/time code of the date and time at which the advertisement was broadcast. The interface controller 32 accesses the data in the RAM 64 and provides the data to the home computer 14.

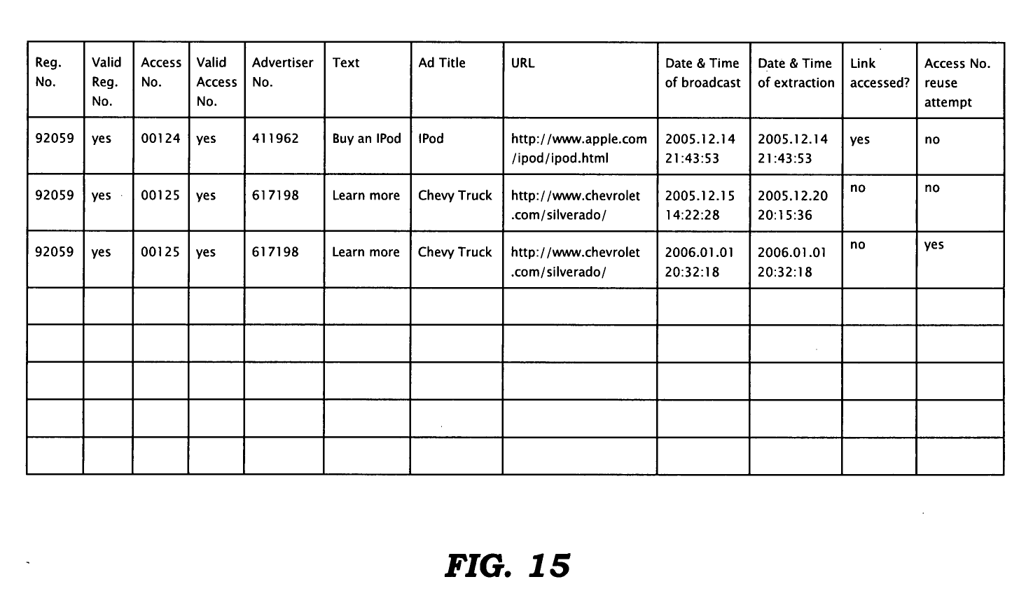

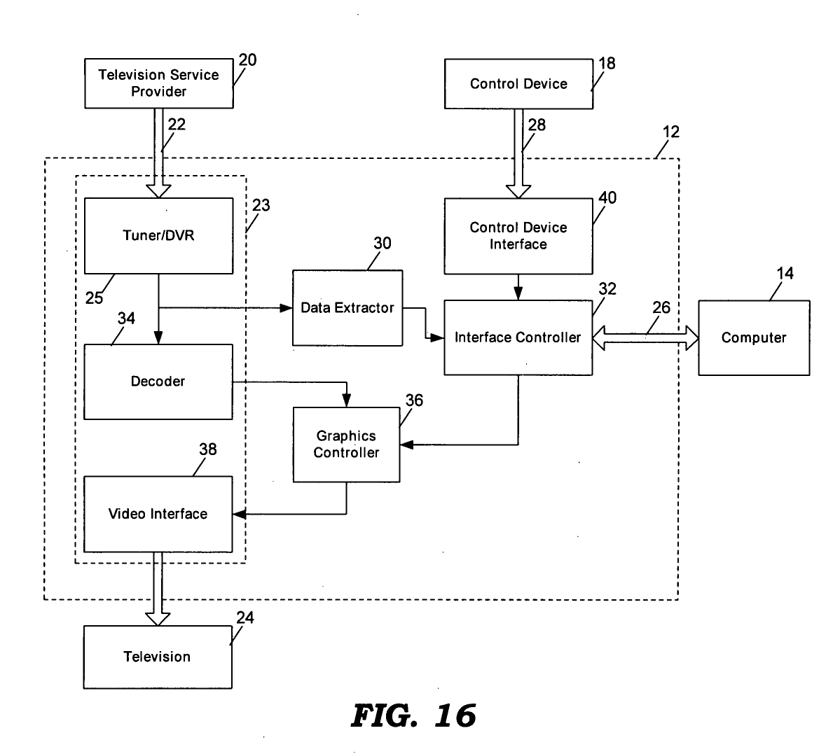

With reference to FIG. 14B, the processor 44 of the home computer 14 accesses the list of valid access numbers and registration codes that was downloaded from the access number central server 304 and determines whether the registration code extracted from the user data section of the advertisement is in the list (step 422). If not, the registration code is assumed to be invalid. In this case, the registration code, access number, time/date code, link text, webpage URL and advertisement title are written to a log file stored on the home computer 14 along with a code indicating that the registration code was determined to be invalid (step 424). An example of the format of the log file is depicted in FIG. 15. If the registration code is invalid, no further processing of the user data is performed and no link information appears when the advertisement is displayed on the television 24.

If the registration code is determined to be valid at step 422, the processor 44 of the home computer 14 determines whether the access number extracted from the user data section of the advertisement is in the previously-downloaded list and is associated with the registration code extracted from the user data section (step 426). If the access number is not in the list or it is not assigned to the extracted registration code, the access number is assumed to be invalid. In this case, the registration code, access number, time/date code, link text, web page URL and advertisement title are written to the log file along with a code indicating that the access number was determined to be invalid (step 424). If the access number is invalid, no further processing of the user data is performed and no link information appears when the advertisement is displayed on the television 24.

If the registration and access numbers are both determined to be valid, the processor 44 accesses the log file to determine whether the access number has been extracted previously (step 428). If the access number is already listed in the log file, which indicates it has been extracted before, the processor 44 reads certain fields of the log file to determine whether the current access number is associated with the same advertisement as the access number listed in the log file (step 430). For example, the processor 44 may read the “date/time of broadcast” field recorded in the log file to determine whether that date/time is the same as the date/time of broadcast associated with the current access number. If the date/time of broadcast associated with the current access number is the same as the date/time of broadcast associated with the access number already listed in the log file, this indicates that the current access number was extracted from a digital media data stream that was previously recorded and replayed from a digital video recorder 25 (DVR) (See FIG. 16).

For example, as shown in the log file depicted in FIG. 15, the Chevrolet truck advertisement associated with access number 00125 was first broadcast on Dec. 15, 2005 at time 14:22:28 (HH:MM:SS). At the time of the live broadcast, the broadcast was recorded on the DVR 25. Several days later (December 20), the user replayed the broadcast that was recorded on the DVR 25, and the television interface system 10 performed the steps 418-432 described above to detect the user data section and extract the advertisement information. These steps are performed during replay of the recorded data stream in the same manner as they would be performed on a “live” data stream, except the date/time of extraction recorded in the log file would indicate that the extraction occurred at some time after the time of the broadcast.

According to the preferred embodiment of the invention, an access number associated with an advertisement recorded on a user's DVR remains valid and can be “reused” multiple times when the advertisement is replayed from the DVR. Thus, when it is determined at step 430 that the current access number is associated with a recorded broadcast, the log file is updated (step 432) and the processing of the web page link in the user data section continues as described at step 202 in FIG. 12.

If it is determined at step 430 that the date/time of broadcast associated with the current access number is not the same as the date/time of broadcast associated with the same access number that was previously recorded in the log file, this indicates that the current access number is being reused. For example, as shown in FIG. 15, access number 00125 was reused in a Chevy truck commercial broadcast on Jan. 1, 2006. In the preferred embodiment of the invention, access numbers are sold for one use only. Accordingly, if the log file indicates that an access number has been broadcast before (as was the access number in the example of FIG. 15), the access number cannot be used again to activate the television interface system 10. In this case, the registration code, access number, time/date code, link text, web page URL and advertisement title are written to the log file along with a code indicating that a reuse of the access number was attempted (step 424). (See FIG. 15.) If a reuse of an access number is attempted, no further processing of the user data is performed and no link information appears when the advertisement is displayed on the television 24.

If it is determined at step 428 that a just-extracted access number is not listed in the log file, meaning it has not been extracted before, the log file is updated (step 432) and the processing of the web page link in the user data section continues as described at step 202 in FIG. 12.

Periodically, the log file is uploaded from the home computer 14 to the access number provider central server 304 via the Internet 16 (step 434). In a preferred embodiment of the invention, the log file is uploaded weekly. The information in the log file may be used by the access number provider 300, the TV broadcasters 308, TV service providers 20 and the advertisers 306 for market research. The log file information may also be used by the access number provider 300 to monitor attempted misuse of the access numbers by the broadcasters 308 or service providers 20.

In a preferred embodiment of the invention, the access number provider, the advertisers, the TV broadcasters and TV service providers communicate and transact business via a communication network 16. It will be appreciated that the communication network 16 may be a computer network, such as the Internet, that supports communications via email, instant messaging and web page access. The network 16 may also be a telephone communication network that supports communication via voice or facsimile transmissions. For example, a TV broadcaster may place an order for a block of access numbers with the access number provider via telephone or facsimile, and the access number provider may deliver the block of access numbers via telephone or facsimile. It will also be appreciated that these and other communications may be conducted via regular mail or courier. For example, an advertiser may transfer a recording of an advertisement to a TV broadcaster or TV service provider by regular mail or other courier. Thus, it should be appreciated that the invention is not limited to any particular means of communicating between the access number provider, the advertisers, the TV service providers and the TV broadcasters.

In a preferred embodiment of the invention depicted in FIG. 16, the tuner/DVR 25 is a part of the circuitry 23 needed to receive the television channels provided by the cable or satellite TV service provider 20. When the television/computer interface 12 is inactive or disabled, such as due to lack of a valid access number in the received data stream, the circuitry 23 continues to operate to tune, record and decode the digital media data stream provided by the service provider 20. In this manner, television viewing is not interrupted when the television/computer interface 12 is inactive. Preferably, the circuitry 23 and the television/computer interface 12 are contained within a single housing, such as a set-top box. This set-top box may be provided to the TV consumer by the cable or satellite TV service provider 20, such as when the consumer subscribes to receive the TV programming from the service provider 20.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for providing supplemental program information to a television display device in conjunction with a television program, where the supplemental program information is related to the subject matter of the television program, the method comprising:
(a) embedding the supplemental program information and an access number in a digital video data stream of the television program;
(b) transmitting the digital video data stream of the television program;
(c) receiving the digital video data stream of the television program;
(d) extracting the access number from the received digital video data stream of the television program; and
(e) determining based at least in part on the extracted access number whether the supplemental program information is to be provided to the television display device.

2. The method of claim 1 wherein the television program is a television advertisement and the supplemental program information is advertising information related to the subject matter of the television advertisement.

3. The method of claim 1 further comprising (f) acquiring the access number from an access number provider prior to step (a).

4. The method of claim 1 further comprising:
(f) associating the access number with a television broadcaster; and
step (b) further comprising the television broadcaster transmitting the digital video data stream of the television program with the associated access number embedded therein.

5. The method of claim 1 further comprising (f) compiling a list of numbers associated with the television broadcaster, the list of numbers including a plurality of listed access numbers associated with the television broadcaster.

6. The method of claim 5 further comprising:
(g) accessing the list of numbers associated with the television broadcaster; and
step (e) further comprising:
(e1) determining whether the extracted access number corresponds to at least one of the plurality of listed access numbers; and
(e2) determining that the supplemental program information is to be provided to the television viewer if the extracted access number corresponds to at least one of the plurality of listed access numbers.

7. The method of claim 5 further comprising:
step (f) further comprising associating the listed access numbers with a listed broadcaster registration code assigned to the television broadcaster and compiling the list of numbers to include the listed broadcaster registration code;
(g) embedding a broadcaster registration code in the digital video data stream of the television program prior to step (b);
(h) extracting the broadcaster registration code from the digital video data stream of the television program; and
step (e) further comprising:
(e1) determining whether the extracted broadcaster registration code corresponds to the listed broadcaster registration code;
(e2) determining whether the extracted access number corresponds to at least one of the listed access numbers;
(e3) determining whether the extracted broadcaster registration code is associated with the extracted access number; and
(e4) determining that the supplemental program information is to be provided to the television display device if the extracted broadcaster registration code is associated with the extracted access number.

8. The method of claim 5 further comprising (g) downloading the list of numbers to a home computer associated with the television viewer.

9. The method of claim 1 further comprising:
(f) determining whether the extracted access number has been previously extracted from a digital media data stream; and
step (e) further comprising determining whether the supplemental program information is to be provided to the television display device based at least in part on whether the extracted access number has been previously extracted from a digital media data stream.

10. The method of claim 1 further comprising (f) writing log information to a log file, the log information indicative of content of the supplemental program information.

11. The method of claim 10 further comprising:
step (f) comprising writing the log information to the log file on a home computer associated with the television viewer; and
(g) uploading the log file via a communication network to a server computer associated with an access number provider.

12. The method of claim 2 further comprising:
(f) embedding an advertiser identification number in the digital video data stream of the television advertisement prior to step (b), wherein the advertiser identification number is associated with an advertiser sponsoring the television advertisement;
(g) extracting the advertiser identification number from the digital video data stream of the television advertisement; and
step (e) further comprising determining that the advertising information is to be provided to the television viewer based at least in part on the extracted advertiser identification number.

13. The method of claim 5 further comprising:
step (f) further comprising associating one or more of the listed access numbers with a listed advertiser identification number assigned to an advertiser sponsoring the advertisement, and compiling the list of numbers to include the listed advertiser identification number;
(g) embedding an advertiser identification number in the digital video data stream of the television program prior to step (b);
(h) extracting the advertiser identification number from the digital video data stream of the television program; and
step (e) further comprising:
(e1) determining whether the extracted advertiser identification number corresponds to the listed advertiser identification number;
(e2) determining whether the extracted access number corresponds to at least one of the listed access numbers;
(e3) determining whether the extracted advertiser identification number is associated with the extracted access number; and
(e4) determining that the supplemental program information is to be provided to the television display device if the extracted advertiser identification number is associated with the extracted access number.

14. The method of claim 1 wherein step (a) further comprises embedding a uniform resource locator pointing to a web page related to subject matter of the television program.

15. The method of claim 1 wherein step (a) further comprises embedding a title of the television program, the time and date of broadcasting the television program, and text to be graphically inserted into the television program when the television program is displayed on a television display device.

16. A digital media interface apparatus for providing supplemental program information to a television display device in conjunction with a television program, where the supplemental program information is related to the subject matter of the television program, the apparatus comprising:
a television/computer interface for receiving a digital media data stream containing the television program having an access number embedded therein and for extracting the access number from the digital media data stream;
a computer in communication with the television/computer interface and in communication with a communication network, the computer for receiving the extracted access number from the television/computer interface, for receiving a list of numbers including listed access numbers via the communication network, for determining whether the extracted access number corresponds to at least one of the listed access numbers, and for providing the supplemental program information to the television/computer interface if the extracted access number corresponds to at least one of the listed access numbers; and
the television/computer interface further for combining the supplemental program information with the television program to form a combination video signal in a format compatible for display on the television display device.

17. The digital media interface apparatus of claim 16 further comprising:
the television/computer interface further for receiving the digital media data stream containing the television program having a broadcaster registration code embedded therein and for extracting the broadcaster registration code from the digital media data stream; and
the computer further for receiving the list of numbers including at least one listed broadcaster registration code associated with the plurality of listed access numbers, for receiving the extracted broadcaster registration number from the television/computer interface, for determining whether the extracted broadcaster registration code corresponds to the listed broadcaster registration code, and for providing the supplemental program information to the television/computer interface if the extracted access number corresponds to at least one of the listed access numbers and the extracted broadcaster registration code corresponds to the listed broadcaster registration code.

18. The digital media interface apparatus of claim 16 further comprising the computer for determining whether the extracted access number has been previously extracted from a digital media data stream, and for providing the supplemental program information to the television/computer interface if the extracted access number corresponds to at least one of the listed access numbers and the extracted access number has not been previously extracted from a digital media data stream.

19. The digital media interface apparatus of claim 16 further comprising:
the television/computer interface for receiving the digital media data stream containing the television program having a uniform resource locator embedded therein, where the uniform resource locator points to a web page related to subject matter of the television program, the television/computer interface further for extracting the uniform resource locator from the digital media data stream; and
the computer further for providing access to the web page for viewing on the television display device if the extracted access number corresponds to at least one of the listed access numbers.

20. A digital media interface apparatus for providing supplemental program information to a television display device in conjunction with a television program, where the supplemental program information is related to the subject matter of the television program, the apparatus comprising:
means for embedding the supplemental program information and an access number in a digital video data stream of the television program;
means for transmitting the digital video data stream of the television program;
means for receiving the digital video data stream of the television program;
means for extracting the access number from the received digital video data stream of the television program; and
means for determining based at least in part on the extracted access number whether the supplemental program information is to be provided to the television display device.
